(19) United States
(12) Patent Application Publication
(10) Pub. No.: US 2006/0265281 A1
(43) Pub. Date: Nov. 23, 2006

(54) Computer system for facilitating the use of coupons for electronic presentment and processing

(76) Inventors: Joseph J. Sprovieri, Chicago, IL (US); Dennis J. Malinis, Chicago, IL (US)

Correspondence Address: OLSON & HIERL, LTD., 20 NORTH WACKER DRIVE, 36TH FLOOR, CHICAGO, IL, 60606, US

(21) Appl. No.: 11/412,218

(22) Filed: Apr. 26, 2006

Related U.S. Application Data
(60) Provisional application No. 60/674,751, filed on Apr. 26, 2005.

(51) Int. Cl. G06Q 30/00

(52) U.S. Cl. 705/14

(57) ABSTRACT

A computer system for promotion management, analytics and interactive marketing enabling consumers, retailers and product manufacturers to administer all of these activities electronically and in real-time. Consumers have the ability to store paper coupon data and Internet coupon data to an account accessible through the use of a grocery loyalty card, a different type of card, cell phone, PDA, key ring transponder or other portable device or the like capable of storing electronic account data. Online reporting capabilities enable manufacturers and retailers to track and analyze promotion performance, redemption payments, sales dollars, unit volume, accounts receivable, accounts payable and other important data. Manufacturers and retailers have the ability to communicate directly with individual customers or groups of customers to promote their products and services. The system is accessible to consumers, manufacturers and retailers via PC, cell phone, PDA or any device with Internet capabilities.

### CROSS REFERENCE TO RELATED APPLICATIONS

This application claims priority from U.S. provisional application Ser. No. 60/674,751, filed on Apr. 26, 2005, the disclosure of which is hereby incorporated herein by reference in its entirety.

### BACKGROUND OF THE INVENTION

Couponing is the most prevalent method used by manufacturers to promote and market their products. In 1894, Asa Candler, the druggist who bought the formula for Coca-Cola, gave out handwritten tickets for a free glass of this new fountain drink. One year later, C. W. Post distributed the first grocery coupon worth one cent towards the purchase of his new Grape Nuts cereal. Other consumer packaged goods manufacturers (CPG's) recognized the marketing power of coupons and quickly followed suit. Since that time, coupons have become an integral part of promotion strategies. Coupons benefit manufacturers by increasing sales, retailers by generating store traffic and consumers by saving money on purchases.

Throughout their existence, coupons have not changed much. They are still made of paper and need to be manually handled throughout the Coupon Life Cycle. The only significant update to paper coupons was the incorporation of UPC (Universal Product Code) bar code scanning. Grocery stores began scanning product packages in 1974 to speed up the checkout process and keep better track of inventory. Coupons soon began using the same UPC coding to ensure discounts were only applied to products scanned at purchase. When products and coupons are scanned at checkout, the retailers POS (point of sale) system automatically deducts the coupon values from the product prices when a match is found.

Under the current system of paper-based coupon processing, a customer must present a paper coupon corresponding to the goods or services purchased at the point of sale. Upon checkout, the retailer scans the paper coupon and discounts the customer's purchase price accordingly. The retailer retains the paper coupons, bundles and sends them all to a third party clearinghouse for processing. The clearinghouse manually sorts, counts and inventories the paper coupons. The clearinghouse then prepares and submits redemption payment invoices to accompany the physical paper coupons pertaining to each product manufacturer and forwards everything to each product manufacturer's agent. The manufacturer's agent then provides each product manufacturer with redemption volume data, redemption payment data and the physical coupons to be destroyed. The manufacturer then remits payment for services to the manufacturer's agent and clearinghouse and must pay the retailer for the face value of the coupons plus a stated handling fee per coupon.

A great deal of cost is incurred to print, distribute, handle and clear paper coupons. Free Standing Inserts (FSI's) found in Sunday newspapers account for the vast majority of all coupons distributed. Direct mail, product packages and in-store coupons makeup most of the balance. Today's mass scale distribution of coupons is incapable of targeting specific customers. It's a shotgun approach circulating approximately 300 billion coupons per year with only 1% of the total being redeemed on average. Traditional paper coupons have a high cost per product sold and a low ROI (return on investment).

Low coupon response rates can be attributed in part to difficulties providing relevant offers to relevant customers. For example, consumers who do not own pets would have no interest in coupons for pet products. Consumers who do not have a baby would not be interested in coupons for baby products. As such, a great deal of advertising dollars are wasted on consumers who have no interest in particular products. It may also be difficult for consumers to find offers for products that are of interest. Therefore, a need exists for a more efficient and effective method to target promotions for the right products to the right customers.

Low coupon response rates can also result from difficulties consumers have clipping, sorting and managing coupons they accumulate. It is time consuming and cumbersome to manually track multiple paper coupons and ensure they are used before their expiration dates. Consumers may not be able to find particular coupons before shopping, may fail to use them in time, or forget to use them altogether. Therefore, a need exists to help consumers track and manage coupons in order to maximize their savings opportunities.

When a consumer presents a paper coupon at the point of sale, the retailer discounts the purchase price accordingly. Paper coupons delay the checkout process. Scanning each coupon individually takes time. Waiting for a customer to search through their belongings for coupons they want to use takes time. Coupons that do not scan properly take time. The physical coupons accepted are bundled together and sent to a retail clearinghouse to be redeemed. After the clearinghouse sorts, counts and processes the coupons, it reports the redemption data to the manufacturer's agent. The agent then reports the redemption data to the product manufacturer for payment. Retailers receive the discount amount they pass on to the consumer plus a handling fee. It may take up to eight weeks for retailers to be reimbursed for the coupons they accept. Therefore, a need exists to expedite the coupon acceptance, reconciliation and redemption payment processes.

Manufacturers and retailers commonly experience discrepancies when reconciling coupons submitted for reimbursement against products sold. This is due in part to an ever increasing issue of fraud which is estimated to be a $500 million per year problem. Graphic design programs, scanners, color printers, color photocopiers and the like make it possible for consumers to manipulate paper coupons. Moreover, deceitful individuals may conspire to redeem coupons for products that were never sold. Therefore, a need exists to minimize or eliminate the potential for fraudulent coupon activities.

The greatest weakness of the current paper-based coupon process is the inability to connect coupon use with the customers who use them. The competition provides data regarding the number of coupons redeemed for a particular promotion. The competition may also break that number down to provide data by region, market or store, but cannot tie coupon use to individual customers. Demographic and purchase behavior data is invaluable to determining which products to promote to particular customer segments. Product manufacturers are constantly trying to understand consumers purchase motivation and be smarter and more efficient in their efforts to reach them. Therefore, a need exists for a superior marketing tool to improve communication between consumers, manufacturers and retailers.

### SUMMARY OF THE INVENTION

Such a paper-based system to process paper coupons is costly, inefficient and cumbersome. Additionally, the manual effort and number of touch points required from beginning to end makes for a lengthy process. The current process is vulnerable to fraud due to paper coupons susceptibility to unauthorized manipulation and duplication. Moreover, consumer purchase and demographic information cannot be matched to the use of paper coupons. The loss of this data in the process precludes effective data mining by manufacturers and retailers. Thus, there is a need in the art for a solution to overcome these inefficiencies.

The present invention addresses these problems by providing a system and a method for streamlined electronic promotion processing with capabilities to analyze purchase behavior, demographic data and facilitate one-to-one communication between consumers, manufacturers and retailers. Customers have access to more savings opportunities for their purchases than what the prior art provides. The present invention also delivers operational efficiencies throughout the entire coupon process and provides manufacturers and retailers with an unparalleled level of purchase intelligence, analytical tools, data mining and interactive marketing capabilities.

Under the present invention, consumers create an electronically stored account online. For the sake of this discussion, these accounts are stored on a remote database server, although it is understood that the present invention can also be implemented through an ASP (application service provider) model, a data warehouse, client based servers or any centralized or decentralized linked network system. As part of the account creation process, the consumer provides demographic data including, but not limited to, age, gender, ethnic group, marital status, number of children in the household, education level, income level and geographical location. The consumer also provides his/her product preferences, purchase preferences, store preferences and shopping preferences to be associated with targeted coupons and promotions available to the account. A paper coupon is added to the account by entering the coupons numeric barcode data via the website. An Internet coupon can be added to the account via the website by keyword search, through the use of a hierarchical directory tree or by selecting individually targeted product offers. Once a coupon is electronically associated with the account, it is available immediately for use.

A consumer can associate multiple coupons with the account, view all of the coupons associated with the account and sort coupons by a product category, value, expiration date, etc. A consumer can also view and print reports displaying information such as coupons and promotions stored to the account, products purchased and dollars saved. In addition, the consumer website includes a collaborative filtering capability that recommends Internet coupons for products preferred by other consumers with similar purchase patterns or demographic profiles. Functionality is also present to identify coupons for similar or complimentary products in relation to previously used or currently selected coupons associated with the consumer account.

Consumer accounts on the remote database server are also associated with a portable device easily carried by the consumer. While the following discussion focuses on accessing coupons and promotions through the use of a grocery loyalty card, it is understood that a different type of card, cell phone, PDA (Personal Digital Assistant), key ring transponder or other portable device capable of storing electronic account data can also be used and that such devices may be independent of any retailer operation. Similarly, the consumer account may also be accessible by use of biometric data such as fingerprints, retinal scans or personal identification numbers that otherwise uniquely identify a consumer. Since paper and Internet coupons are electronically associated with the consumers account, the need to clip, manage and carry paper coupons is obviated. To use the electronically stored coupons, a consumer presents their grocery loyalty card to be scanned by the retailer at the point of sale. A register or computer at the point of sale identifies the account number associated with the card and connects to the remote database server to identify the various coupons and promotions associated with the consumer account. Coupons and promotions associated with the account are checked against products scanned at the point of sale. If an available coupon or promotion matches a product scanned, the register or computer at the point of sale deducts the appropriate discount from the price of the item purchased. The coupon is simultaneously rendered unavailable for reuse from the consumers account at the remote database server and added to the retailers account history on the remote database server for redemption processing. By matching coupons to each transaction in this way, an audit trail is created which minimizes or eliminates reconciliation discrepancies between manufacturers and retailers for coupons accepted versus products sold.

After a coupon is accepted from the consumer through the use of the card, the redemption data is stored in the retailers account and is electronically sorted, tallied and presented to the manufacturer for payment. The present invention contemplates the use of electronic presentment, redemption and payment, thereby achieving improved efficiency through the reduction of cumbersome manual operations and other processing delays. Manufacturers interface with the remote database server to obtain real-time promotion results to the customer level and to query information such as sales dollars, unit volume, etc. The present invention also permits manufacturers to make electronic payments to retailers for coupons processed and redeemed electronically. Data captured in relation to electronic coupon usage, customer identity, demographics, purchase behavior, store location and the like lends itself to a wide variety of data mining capabilities.

The system can also be queried by a manufacturer to provide existing and/or user defined reports to assess promotion performance. Manufacturers use this information to understand how promotions perform in total and who responds to them individually. Depending on their performance, Internet promotions can be modified instantly to improve their chances of meeting desired marketing objectives. Under the electronic system, a manufacturer can choose to increase or decrease a coupon's value, extend or shorten expiration dates or cancel a promotion altogether if it's not working. Once a paper coupon is distributed, there is no turning back.

The present invention thus provides a simplified way for manufacturers to access and analyze data to promote their brands more efficiently and effectively. Manufacturers track individual items purchased to better understand the buying behavior of its customers. The present invention tracks brand and category purchases in order to segment customers as brand loyal, brand switcher and category never-buy. Manufacturers have access to a wealth of data to determine the best way to promote their products. The interactive marketing capabilities of the present invention are more efficient, effective and less costly than the prior art.

Since each coupon accepted through the use of grocery loyalty cards can be tracked to an individual customer, and since each consumer account includes demographic data, this information makes it possible for manufacturers to understand exactly who is responding to their promotions. This demographic data is used by manufacturers to develop more efficient and effective coupon and other promotional campaigns in order to target the right products, to the right customers, at the right time.

Retailers benefit from the present invention through improved operational efficiencies and reduced operational costs. Electronic coupon presentment expedites the checkout process, essentially eliminates the opportunity for fraud and misredemption, reduces labor costs involved in accepting and accounting for paper coupons and allows quicker receipt of redemption payments to improve cash flow. Demographic and purchase behavior data tracked by the central server system is used by retailers to better understand customer loyalty in order to manage those relationships individually.

The method of coupon processing that is the subject of the present invention thus offers consumers a more convenient way to save on products they buy, while providing manufacturers and retailers operational efficiencies by streamlining the coupon redemption process and providing an unparalleled level of purchase intelligence, analytical tools, data mining and interactive marketing capabilities.

### BRIEF DESCRIPTION OF THE DRAWINGS

Objects and embodiments of the invention are described below with reference to the accompanying drawings, which are briefly described below.

FIG. 1 is a diagram illustrating the system embodying the invention;

FIG. 2 is an illustration of the website map of www.couponwerks.com;

FIG. 3 consists of FIG. 3A through FIG. 3N and illustrate the web pages displayed at www.couponwerks.com;

FIG. 4 illustrates the coupon life cycle;

FIG. 5 illustrates a paper coupon and its corresponding numeric barcode data;

FIG. 6 consists of FIG. 6A and FIG. 6B and are flow charts illustrating the consumer web application process flow;

FIG. 7 consists of FIG. 7A through FIG. 7M, illustrating the web pages displayed through an example process of adding coupons to an account by a consumer;

FIG. 8 consists of FIG. 8A through FIG. 8D and are flow charts illustrating the manufacturer web application process flow; and

FIG. 9 is a flow chart illustrating the retailer web application process flow.

### DETAILED DESCRIPTION OF THE PREFERRED EMBODIMENT

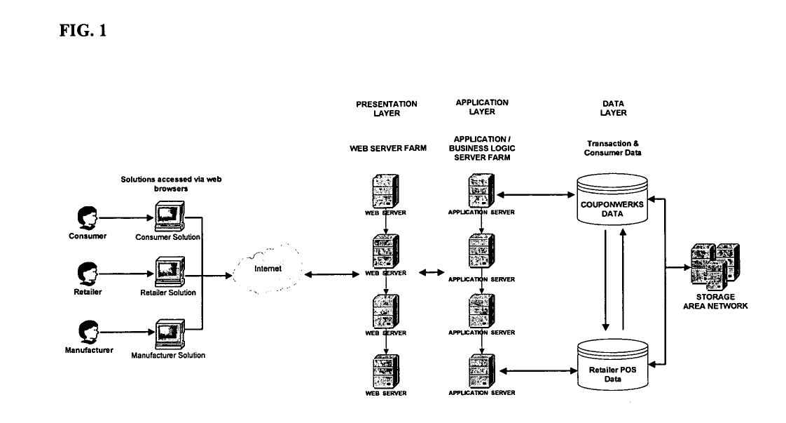

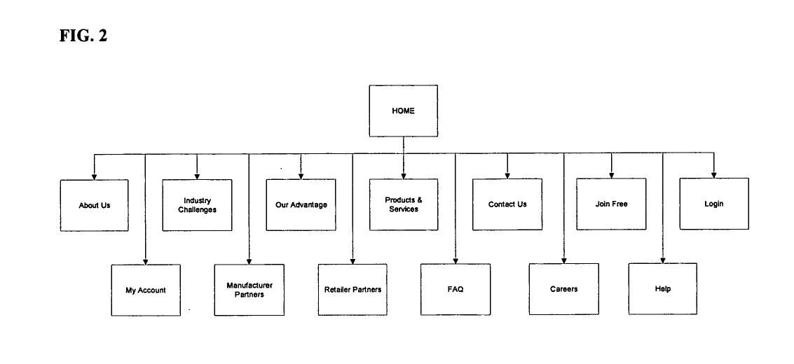

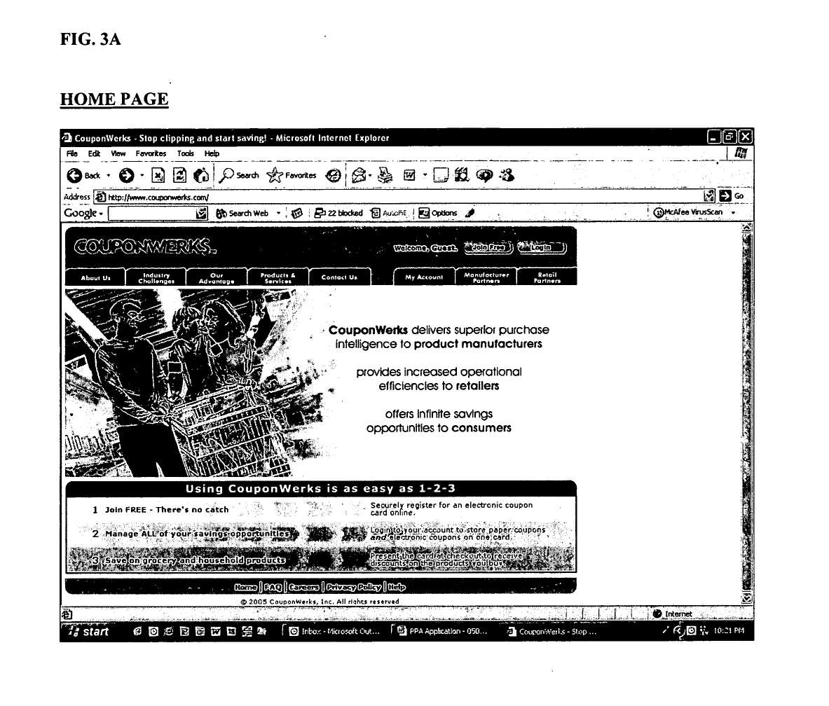

FIG. 1 illustrates the technical architecture of the 3-tiered web-based system. It consists of a presentation layer, application layer and data layer. All three customers (consumers, manufacturers and retailers) access their respective applications through a designated website. Each application will be platform independent and accessible from a PC web browser or any other web-enabled device such as a cell phone, PDA, etc. All dynamic web pages will be served to the presentation layer via the web servers. The system application and business logic will reside on the application/business logic servers where primary system processing occurs. The data layer is comprised of the present inventions data warehouse, the retailer POS (point of sale) data warehouse and the storage area network. Records stored in the present inventions data warehouse include, but are not limited to, member profiles, partner profiles and coupons. Records stored in the retailer POS data warehouse include, but are not limited to, transaction history and product pricing. The storage area network connects the present inventions data warehouse and retailer POS data warehouse to more efficiently utilize data storage.

FIG. 2 illustrates the site map for the website hosted at www.couponwerks.com.

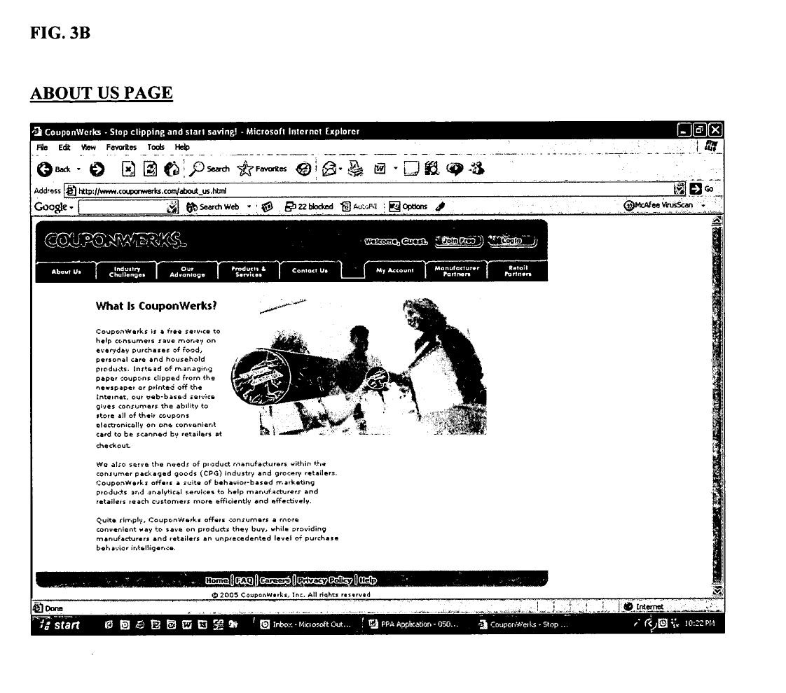

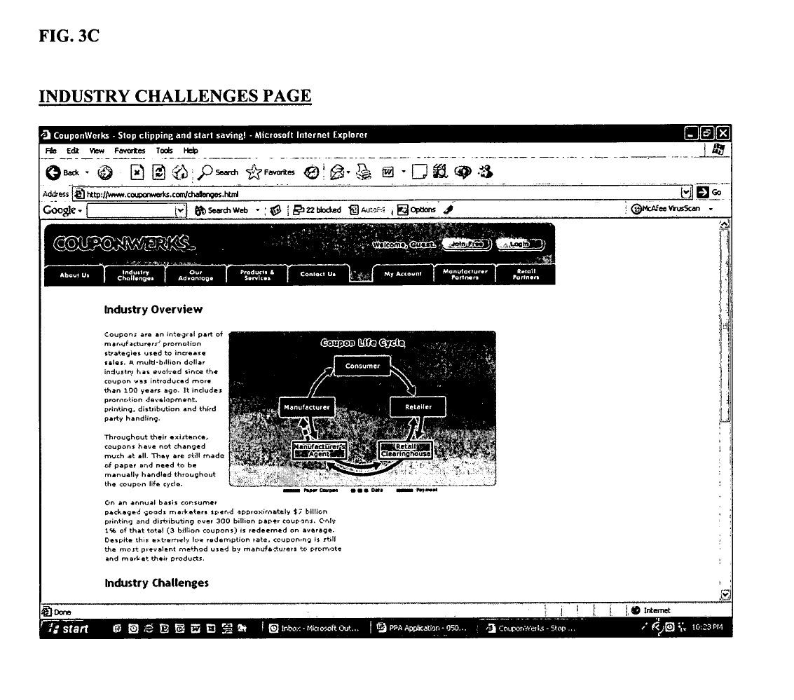

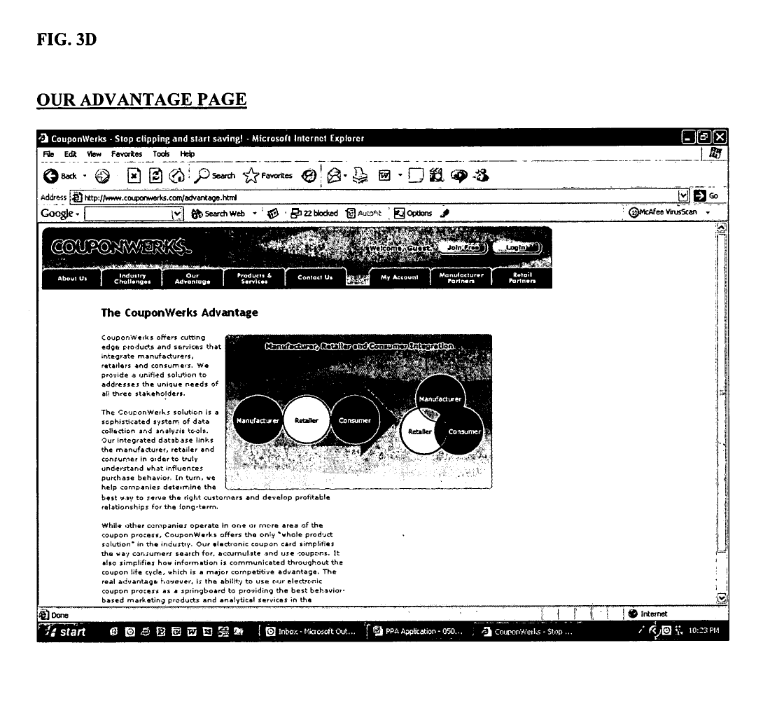

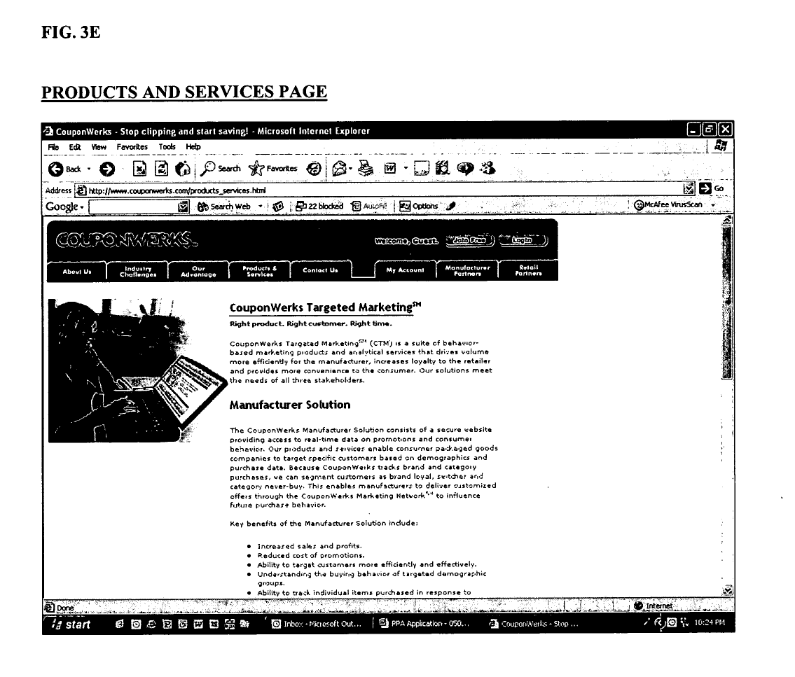

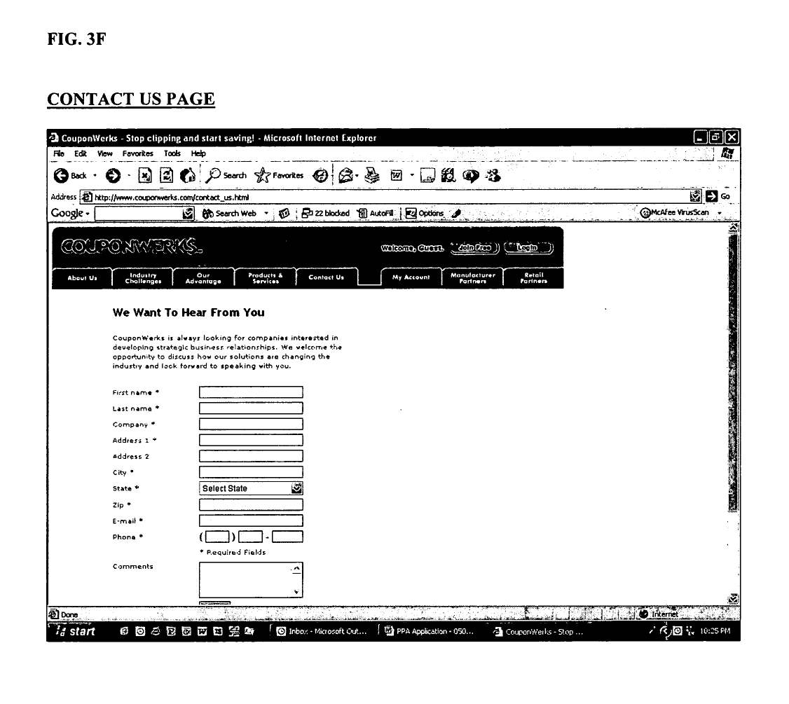

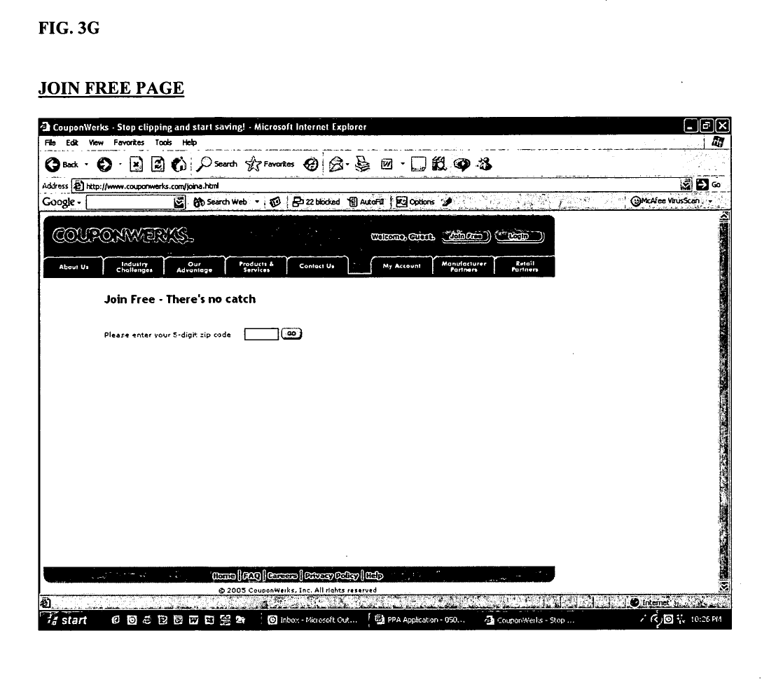

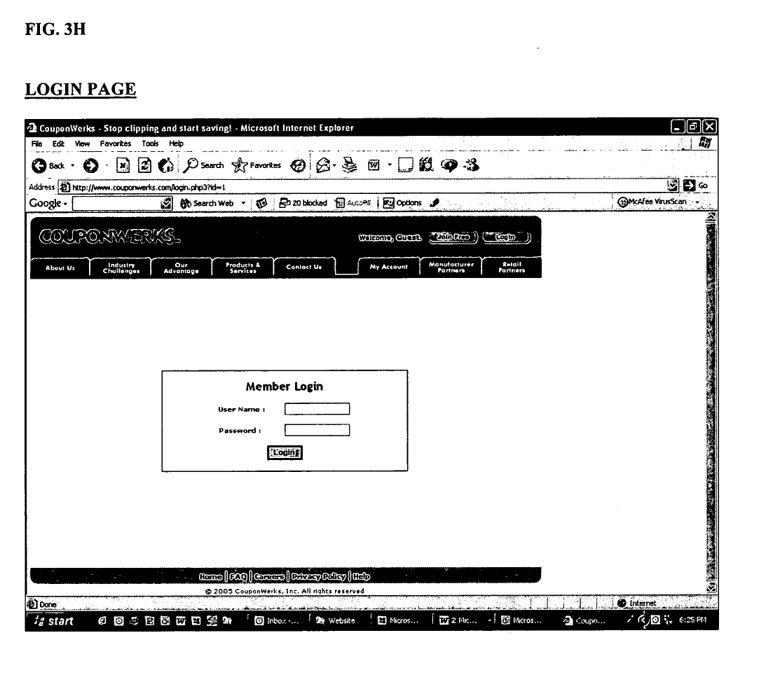

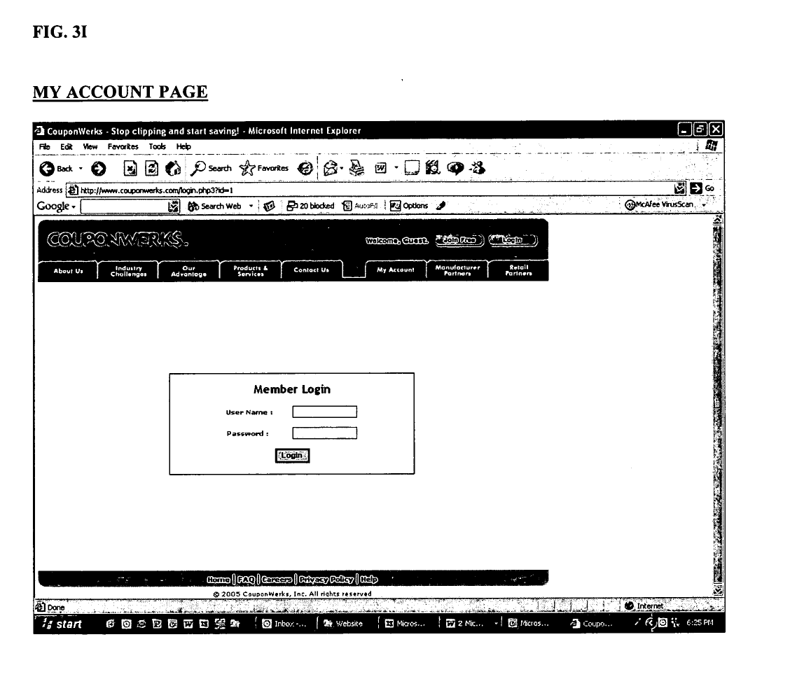

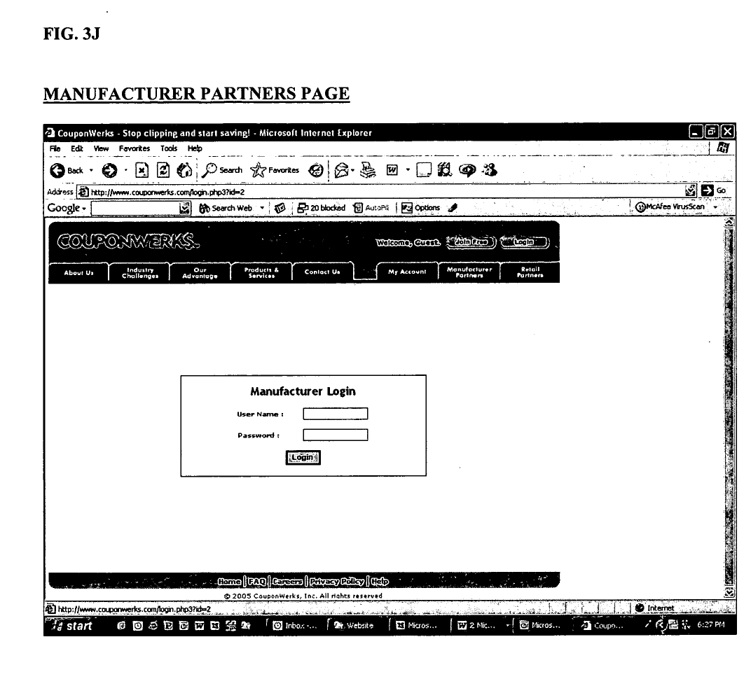

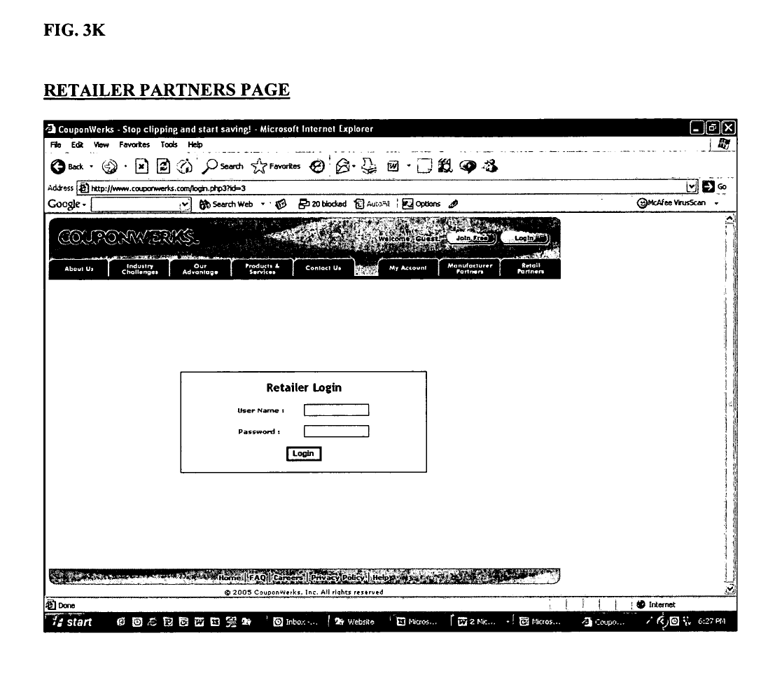

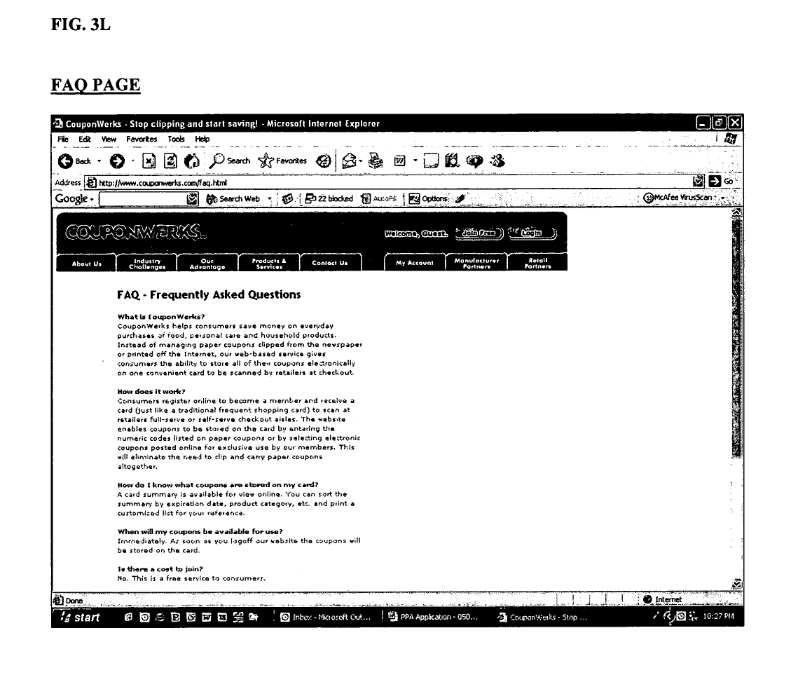

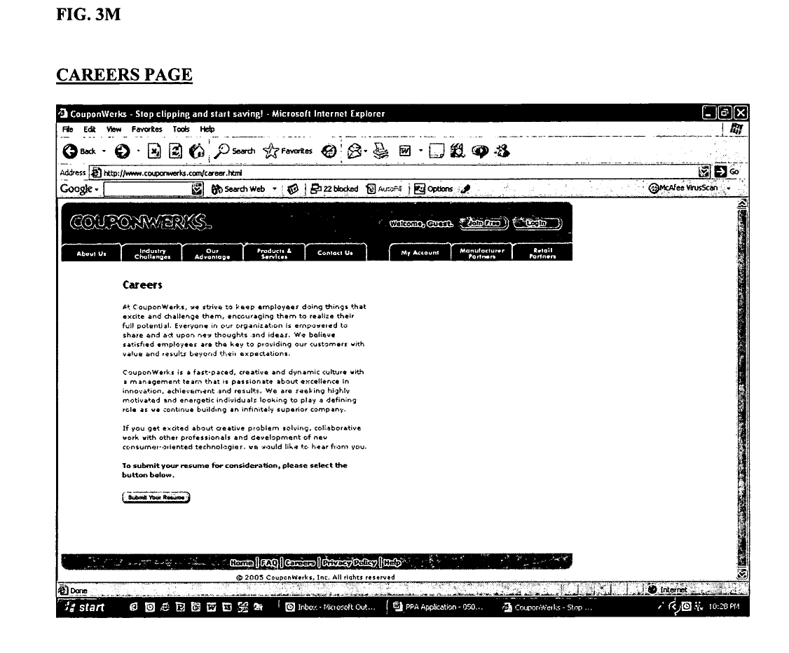

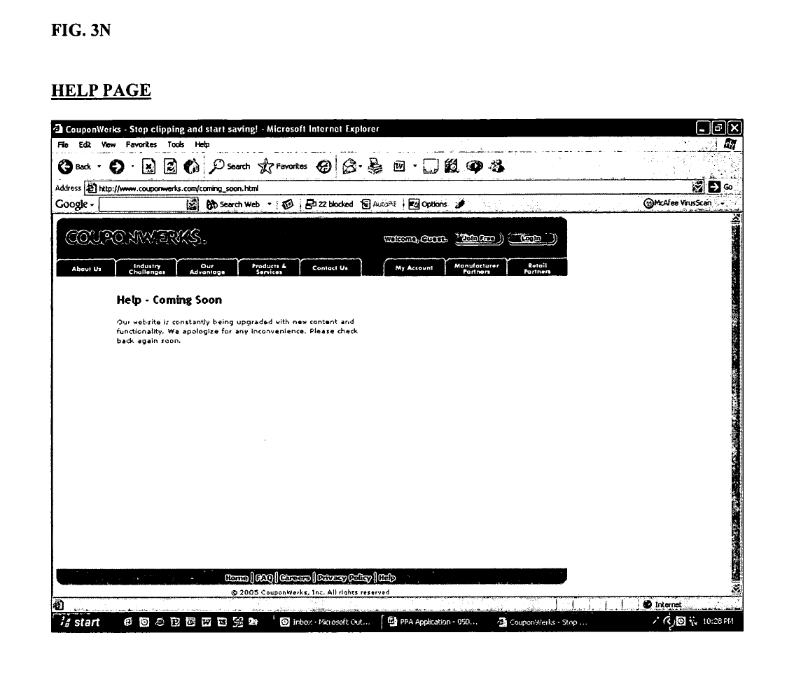

FIG. 3A shows the “Home” page of www.couponwerks.com.

FIG. 3B shows the “About Us” page. The web copy reads as follows:

What Is CouponWerks?

CouponWerks is a free service to help consumers save money on everyday purchases of food, personal care and household products. Instead of managing paper coupons clipped from the newspaper or printed off the Internet, our web-based service gives consumers the ability to store all of their coupons electronically on one convenient card to be scanned by retailers at checkout.

We also serve the needs of product manufacturers within the consumer packaged goods (CPG) industry and grocery retailers. CouponWerks offers a suite of behavior-based marketing products and analytical services to help manufacturers and retailers reach customers more efficiently and effectively.

Quite simply, CouponWerks offers consumers a more convenient way to save on products they buy, while providing manufacturers and retailers an unprecedented level of purchase behavior intelligence.

FIG. 3C shows the “Industry Challenges” page. The web copy reads as follows:

Industry Overview

Coupons are an integral part of manufacturers' promotion strategies used to increase sales. A multi-billion dollar industry has evolved since the coupon was introduced more than 100 years ago. It includes promotion development, printing, distribution and third party handling.

Throughout their existence, coupons have not changed much at all. They are still made of paper and need to be manually handled throughout the coupon life cycle.

On an annual basis consumer packaged goods marketers spend approximately $7 billion printing and distributing over 300 billion paper coupons. Only 1% of that total (3 billion coupons) is redeemed on average. Despite this extremely low redemption rate, couponing is still the most prevalent method used by manufacturers to promote and market their products.

Industry Challenges

The nature of any paper-based process is that a great deal of inefficiency exists compared to an electronic process. There is a tremendous amount of cost involved with the printing, distribution, handling and clearing of paper coupons. Some of the key challenges facing the industry are:

Coupon fraud is estimated to be a $500 million per year problem.

Manual handling of paper is costly, labor intensive and prone to error.

Multiple steps in the coupon life cycle make for a lengthy process.

Hard to handle coupons slow down the checkout process at retail stores.

Product manufacturers know nothing about the consumers they ultimately reach.

The single biggest weakness of the current paper-based process is the lack of consumer information available. Paper coupons are distributed in mass scale and have a very high cost per unit moved. Manufacturers and retailers currently have no way to connect their use with the ultimate consumer.

Marketers are constantly trying to understand customers better and be smarter and more efficient in their efforts to reach them. The industry needs to move away from high cost, low use, low information sharing promotion methods to a behavior-based approach. Otherwise manufacturers and retailers will never be truly effective in reaching and retaining customers.

FIG. 3D shows the “Our Advantages” page. The web copy reads as follows:

The CouponWerks Advantage

CouponWerks offers cutting edge products and services that integrate manufacturers, retailers and consumers. We provide a unified solution to addresses the unique needs of all three stakeholders.

The CouponWerks solution is a sophisticated system of data collection and analysis tools. Our integrated database links the manufacturer, retailer and consumer in order to truly understand what influences purchase behavior. In turn, we help companies determine the best way to serve the right customers and develop profitable relationships for the long-term.

While other companies operate in one or more area of the coupon process, CouponWerks offers the only “whole product solution” in the industry. Our electronic coupon card simplifies the way consumers search for, accumulate and use coupons. It also simplifies how information is communicated throughout the coupon life cycle, which is a major competitive advantage. The real advantage however, is the ability to use our electronic coupon process as a springboard to providing the best behavior-based marketing products and analytical services in the industry.

FIG. 3E shows the “Products & Services” page. The web copy reads as follows:

CouponWerks Targeted Marketing^{SM}

Right product. Right customer. Right time.

CouponWerks Targeted Marketings^{SM} (CTM) is a suite of behavior-based marketing products and analytical services that drives volume more efficiently for the manufacturer, increases loyalty to the retailer and provides more convenience to the consumer. Our solutions meet the needs of all three stakeholders.

Manufacturer Solution

The CouponWerks Manufacturer Solution consists of a secure website providing access to real-time data on promotions and consumer behavior. Our products and services enable consumer packaged goods companies to target specific customers based on demographics and purchase data. Because CouponWerks tracks brand and category purchases, we can segment customers as brand loyal, switcher and category never-buy. This enables manufacturers to deliver customized offers through the CouponWerks Marketing Networks^{SM} to influence future purchase behavior.

Key benefits of the Manufacturer Solution include:

Increased sales and profits.

Reduced cost of promotions.

Ability to target customers more efficiently and effectively.

Understanding the buying behavior of targeted demographic groups.

Ability to track individual items purchased in response to coupon promotions.

Understanding the demographic groups responding to coupon promotions.

Retailer Solution

The CouponWerks Retailer Solution consists of a secure website providing access to real-time data on promotions and consumer behavior. Our products and services enable retailers to reduce coupon processing costs and manage customer relationships on an individual level. Based on the different locations where consumers shop, we can use purchase data to demonstrate to a retailer how loyal they are to their store. This helps retailers to identify their best, as well as “at risk” customers. Through the CouponWerks Marketing Networks^{SM} we can help develop programs designed to increase store traffic.

Key benefits of the Retailer Solution include:

Attracting new customers.

Increased purchases by loyal customers.

Turning secondary customers into primary customers.

Reduced fraud and misredemption of paper coupons.

Improved cash flow from quicker coupon redemption payments.

Reduced labor costs involved with accepting and accounting for paper coupons.

Consumer Solution

The CouponWerks Consumer Solution is a web service providing the opportunity to store paper coupons and electronic coupons on one card. Consumers will no longer need to clip and carry multiple paper coupons to the store. The CouponWerks Marketing Networks^{SM} provides access to a wide variety of product offers. It's a simplified way to search for, accumulate and use coupons to save on food, personal care and household products.

Key benefits of the Consumer Solution include:

One convenient card to carry.

Saves time spent clipping and searching for paper coupons.

Can elect to receive customized offers for products of choice.

Website offers a greater selection of coupons than print media alone.

Website tracks purchasing throughout the year to show consumers what they buy, when they buy and how much they save.

FIG. 3F shows the “Contact Us” page. The web copy reads as follows:

We Want To Hear From You

CouponWerks is always looking for companies interested in developing strategic business relationships. We welcome the opportunity to discuss how our solutions are changing the industry and look forward to speaking with you.

FIG. 3G shows the “Join Free” page where consumers become members. Consumers click the “Join Free” button and enter their 5-digit zip code. If the present inventions service is available in their area, the online registration form appears. If the form does not appear, they can elect to be notified when the service is available in their area.

FIG. 3H shows the “Login” page. This is the first way consumers are able to access the website.

FIG. 31 shows the “My Account” page. This is the second way consumers are able to access the website.

FIG. 3J shows the “Manufacturer Partners” page. This is where consumer product manufacturers access the website.

FIG. 3K shows the “Retailer Partners” page. This is where retailers access the website.

FIG. 3L shows the “FAQ” page. The web copy reads as follows:

FAQ—Frequently Asked Questions

What is CouponWerks?

CouponWerks helps consumers save money on everyday purchases of food, personal care and household products. Instead of managing paper coupons clipped from the newspaper or printed off the Internet, our web-based service gives consumers the ability to store their coupons electronically on one convenient card to be scanned by retailers at checkout.

How does it work?

Consumers register online to become a member and receive a card Oust like a traditional frequent shopping card) to scan at retailers full-serve or self-serve checkout aisles. The website enables coupons to be stored on the card by entering the numeric codes listed on paper coupons or by selecting electronic coupons posted online for exclusive use by our members. This will eliminate the need to clip and carry paper coupons altogether.

How do I know what coupons are stored on my card?

A card summary is available for view online. You can sort the summary by expiration date, product category, etc. and print a customized list for your reference.

When will my coupons be available for use?

Immediately. As soon as you logoff our website the coupons will be stored on the card.

Is there a cost to join?

No. This is a free service to consumers.

How can I become a CouponWerks member?

Click on the “Join Free” button and enter your 5-digit zip code. If our service is available in your area, the online registration form will appear. It will only take a few moments to complete and become a member. If the form does not appear, you can request to be notified when our service will be available in your area.

Why wouldn't your service be available in my area?

Acceptance of our card is dependent upon retailer participation. It will take some time to expand our network of stores and we kindly ask for your patience. So if you try to join and learn our service is not available in your area, please let us know where you shop. We will be sure to tell those stores what their customers want. Our ultimate goal is enabling our members to use their card anywhere they shop nationwide.

FIG. 3M shows the “Careers” page. The web copy reads as follows:

Careers

At CouponWerks, we strive to keep employees doing things that excite and challenge them, encouraging them to realize their full potential. Everyone in our organization is empowered to share and act upon new thoughts and ideas. We believe satisfied employees are the key to providing our customers with value and results beyond their expectations.

CouponWerks is a fast-paced, creative and dynamic culture with a management team that is passionate about excellence in innovation, achievement and results. We are seeking highly motivated and energetic individuals looking to play a defining role as we continue building an infinitely superior company.

If you get excited about creative problem solving, collaborative work with other professionals and development of new consumer-oriented technologies, we would like to hear from you.

To submit your resume for consideration, please select the button below.

FIG. 3N shows the “Help” page.

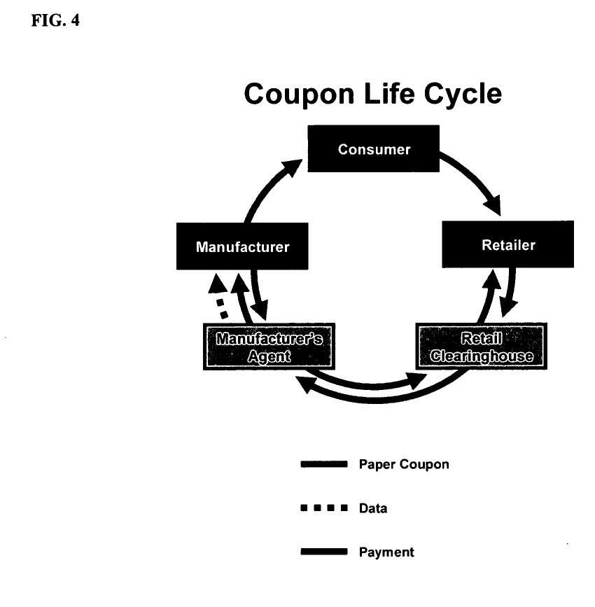

FIG. 4 illustrates the Coupon Life Cycle. Consumers obtain paper coupons through a variety of sources. Consumers clip and manage their coupons, then bring them to the retailer. When the cashier scans the coupons, their value is deducted from the consumer's total purchase amount. The coupons collected by the retailer are bundled together and sent to a retail clearinghouse for processing. The clearinghouse's job is to count the coupons and invoice the manufacturer's agent for payment. The physical coupons and invoice are then sent to the manufacturer's agent. Upon arrival, the coupons are counted again. Each coupon is verified and important information is entered into a database. The agent then provides the manufacturer with the coupon data to use in analyzing their promotions.

The retailer is reimbursed for the value of the coupons accepted plus a handling fee. The retail clearinghouse and manufacturer's agent also receive a fee for their services. The product manufacturer pays the total amount to the manufacturer's agent. The manufacturer's agent takes its cut and pays the retail clearinghouse. The retail clearinghouse then takes its cut and pays the retailer. The entire process can take up to eight weeks from beginning to end.

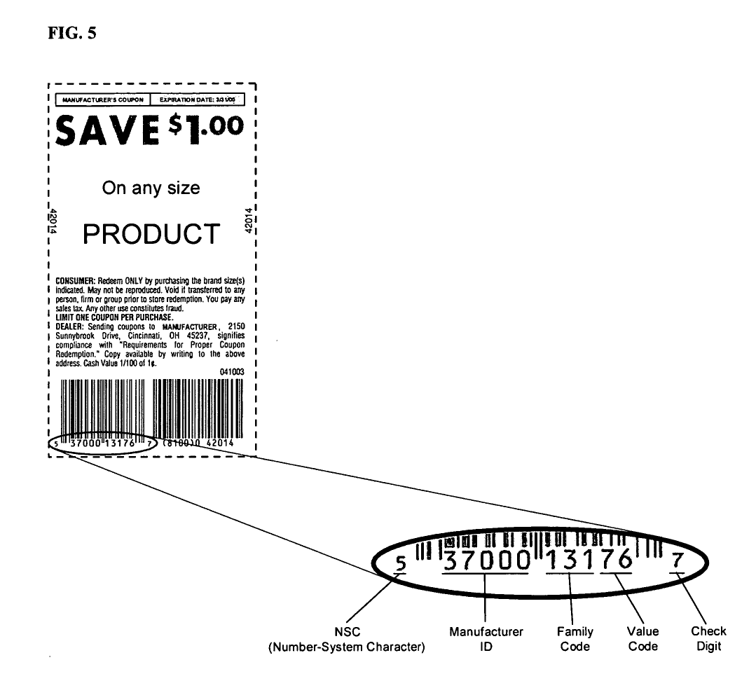

FIG. 5 illustrates a paper coupon and its corresponding numeric code. The prevailing industry standard is a 12 digit Universal Product Code. The first digit of the numeric code, the NSC (Number-System Character), identifies whether the item scanned at checkout is a product or a coupon. The next five (5) digits represent the product MIN (Manufacturer Identification Number). The MIN is a unique code assigned to a given company for use with its products and coupons. The next three (3) digits represent the product family code. The product family code is a unique code assigned to identify specific products. The next two (2) digits represent the value code. The meaning of the value code is set by the industry organization and correlates to the monetary or exchange value of the coupon. The last digit is called the check digit, which allows the retail scanner to determine if it scanned the UPC correctly.

The present invention contemplates the use of a computer server system linked to a communication network. The server system includes a storage device such as fixed or optical drives or other storage means for housing information related to consumer accounts. The server system is also linked to a database of known coupon identification codes such as manufacturer codes, family codes, and value codes for verifying the validity of an entered coupon. This database may be stored locally on a storage device linked with the system, but may also be stored at a remote location and accessible by the server system remotely through a communication network. The server system also includes a transceiver for receiving data from a consumer from the communication network. For example, in a web-based consumer interface, the server system may be connected for customer access to the Internet through the use of a network interface card.

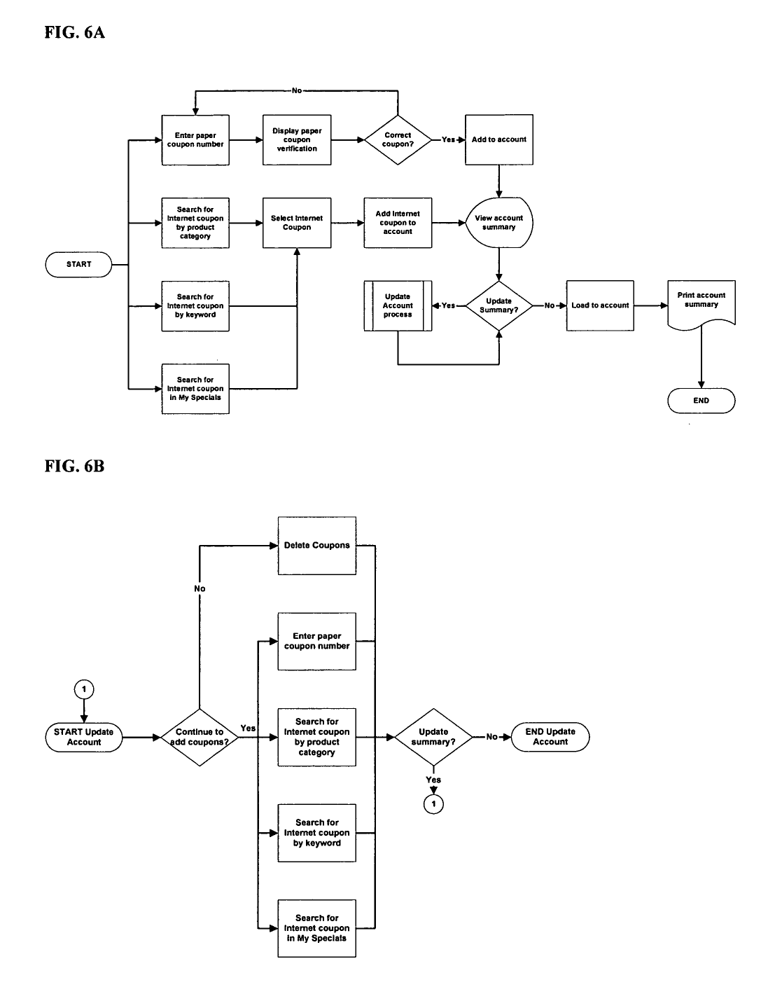

FIG. 6A illustrates the consumer web application process flow. The consumer web application enables the user to manage coupons and other promotions online by adding, deleting or changing product offers and accessing them at the point of sale through the use of a grocery loyalty card. It is understood that a different type of card, cell phone, PDA, key ring transponder or other portable device capable of storing electronic account data can also be used. The product offers may also be accessible by use of biometric data such as fingerprints, retinal scans or personal identification numbers that otherwise uniquely identify a consumer. Prior to using the system, a consumer must first register online (see FIG. 3G) to become a member. The online registration process requires the consumer to provide information including, but not limited to, demographic data, product preferences, store preferences, purchase preferences, shopping preferences, etc. A unique member ID or account number will be assigned for which the consumer establishes a username and password for future access. The corresponding profile associated with each member makes it possible for manufacturers and retailers to understand member purchase behavior on an aggregate level. For those members who elect to receive targeted offers during the registration process, manufacturers and retailers have the ability to communicate with them individually. This increases the likelihood of relevant offers reaching relevant customers.

Upon successful login to the consumer web application, the user is brought to a main menu. The preferred methods to add coupons include, but are not limited to, entering a paper coupon number, searching by product category for Internet coupons posted on the website and performing a keyword search for Internet coupons posted on the website. The user can also check “My Specials” to view coupons and other promotions specifically tailored to his/her preferences. Each of the four branches in the consumer web application process flow represents the preferred methods for creating electronic coupon records to be used in conjunction with the consumers grocery loyalty card.

It is important to note that coupons are not actually stored on the card itself. The electronic coupon data resides in the present invention's data warehouse. When a consumer presents the card at checkout, the retailer POS system identifies the member ID or account number associated with the card, accesses the corresponding records in the present inventions data warehouse and applies the appropriate discounts to the appropriate items purchased. In addition to coupons, instant rebates, trade promotions, buy one get one (BOGO) and other promotional offers are available to members and can be accessed by the card.

The top branch of the consumer web application process flow illustrated in FIG. 6A represents how the user enters a paper coupon number and adds the coupon data to the account electronically. The system currently accepts the prevailing industry barcode formats, but will be updated accordingly to accommodate and stay current with changing industry standards as necessary.

Upon entering a paper coupon number, the system will display a verification window prompting the user to confirm that the offer corresponds to the code entered. If the code is not valid, the system will return an error-handling message. If the coupon recognized by the system is correct, the user can add it to their account. If the coupon recognized by the system is incorrect, the user can go back to the paper coupon entry field and try again. The Coupon validation window will only display for paper coupons and not Internet coupons. When the user is finished entering paper coupon codes, the user has the option to view the card summary to see how many total coupons are stored.

The second branch of the consumer web application process flow illustrated in FIG. 6A represents how the user searches for an Internet coupon by product category and adds the coupon data to the account. The system displays a list of product categories from which the user can choose, each of which contains more specific sub-categories. For example, if the user selects the “Household Needs” category, a drop-down list of product sub-categories appears. When the user selects a sub-category, a menu of corresponding Internet coupons is displayed. To select an Internet coupon, the user checks the box for the desired coupon and adds it to the account. Then the user has the option to view the card summary to see how many total coupons are stored.

The third branch of the consumer web application process flow illustrated in FIG. 6A represents how the consumer searches for an Internet coupon by keyword and adds the coupon data to the account. The user types in a word or phrase in the keyword search field that displays a menu of corresponding Internet coupons. To select an Internet coupon, the user checks the box for the desired coupon and adds it to the account. Then the user has the option to view the card summary to see how many total coupons are stored.

The bottom branch of the consumer web application process flow illustrated in FIG. 6A represents how the consumer searches for Internet coupons in “My Specials” and adds the coupon data to the account. The “My Specials” page contains coupons and other promotions specifically tailored to members who elect to receive targeted offers during the registration process based on their profile. Additionally, manufacturers and retailers have the ability to promote their products to the “My Specials” page of individual members who meet specific targeting criteria. When the user selects “My Specials”, a menu of Internet coupons is displayed. To select an Internet coupon, the user checks the box for the desired coupon and adds it to the account. Then the user has the option to view the card summary to see how many total coupons are stored.

The card summary lists all the Previous Coupons remaining in the account from the users last shopping trip, plus the New Coupons added during the current login session. A red, yellow, green color scheme indicates the expiration status of the coupons. The color green indicates a coupon will not expire for 30 days or more. The yellow color indicates a coupon is expiring soon. The red color indicates a coupon has expired and is no longer available for use.

FIG. 6B illustrates the coupon account update process of the consumer web application process flow in greater detail. The user has the option of deleting coupons from the account as well as adding additional paper or Internet coupons to the account.

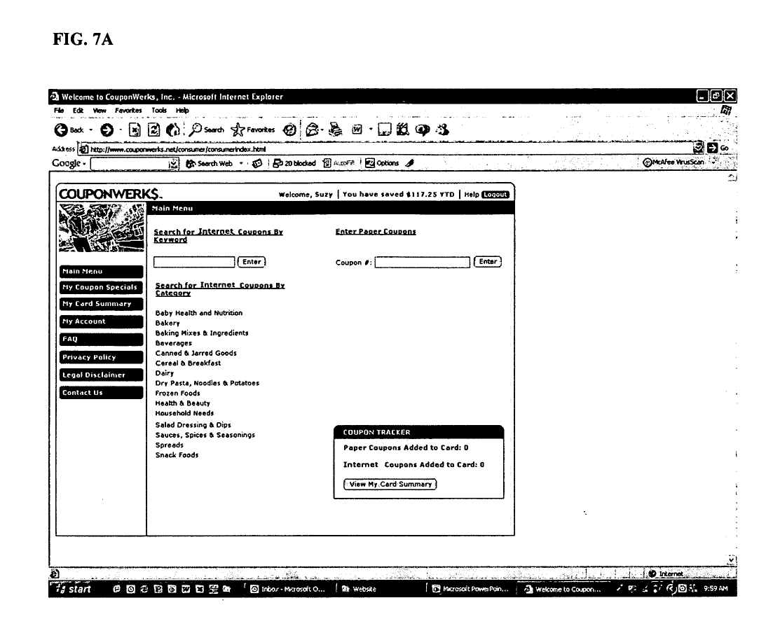

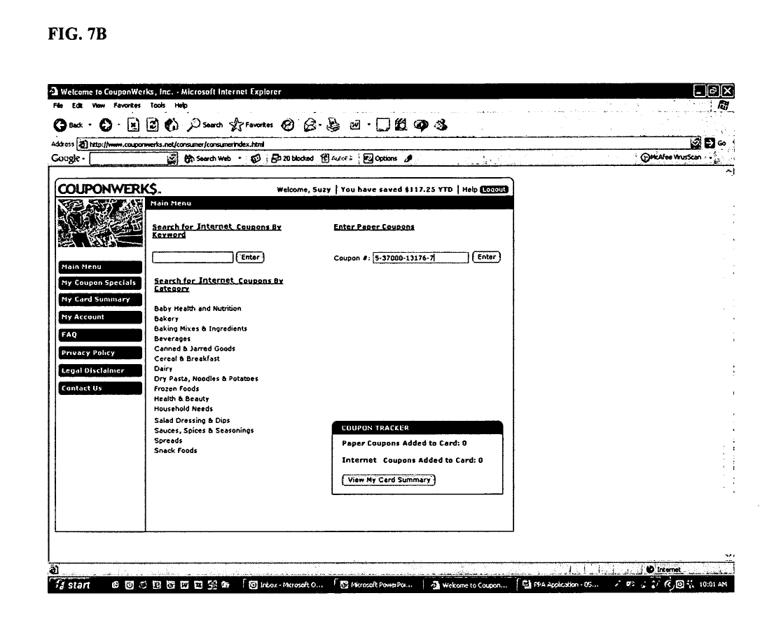

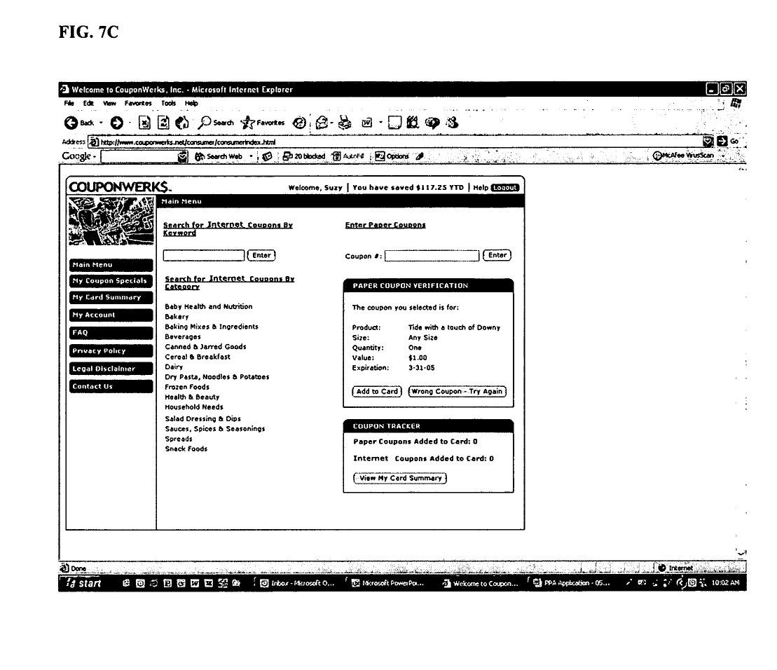

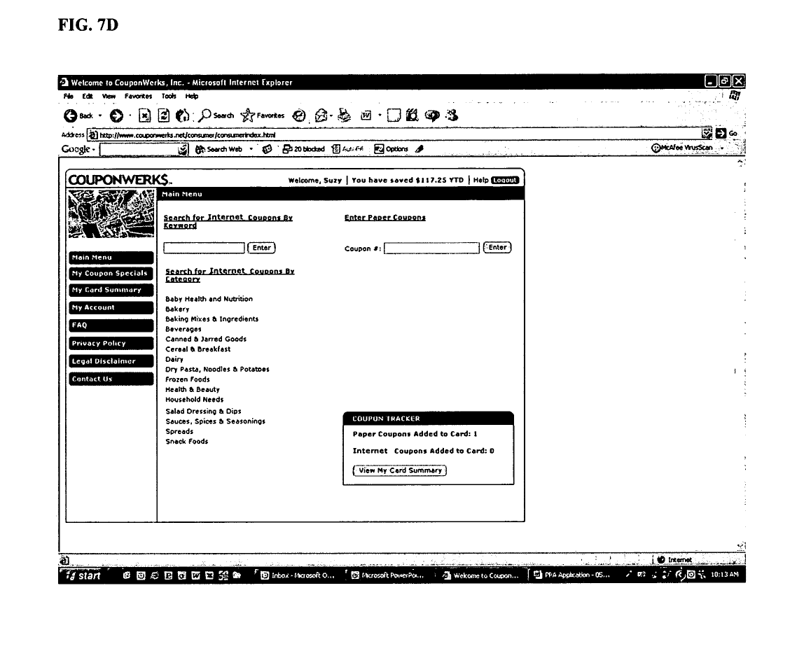

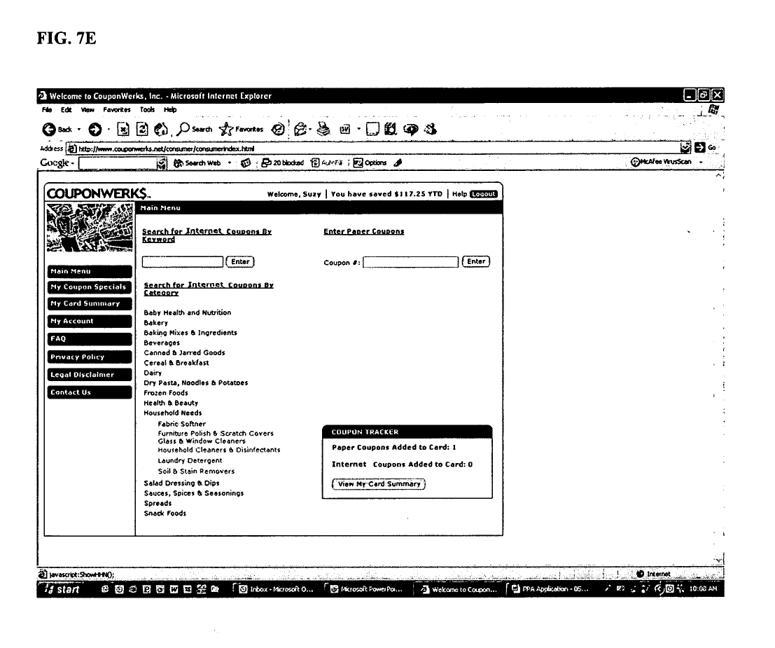

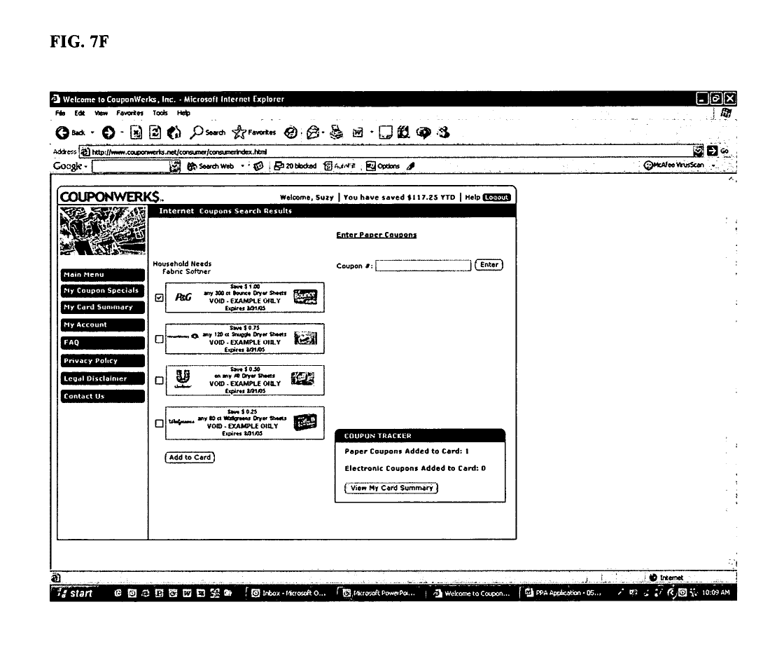

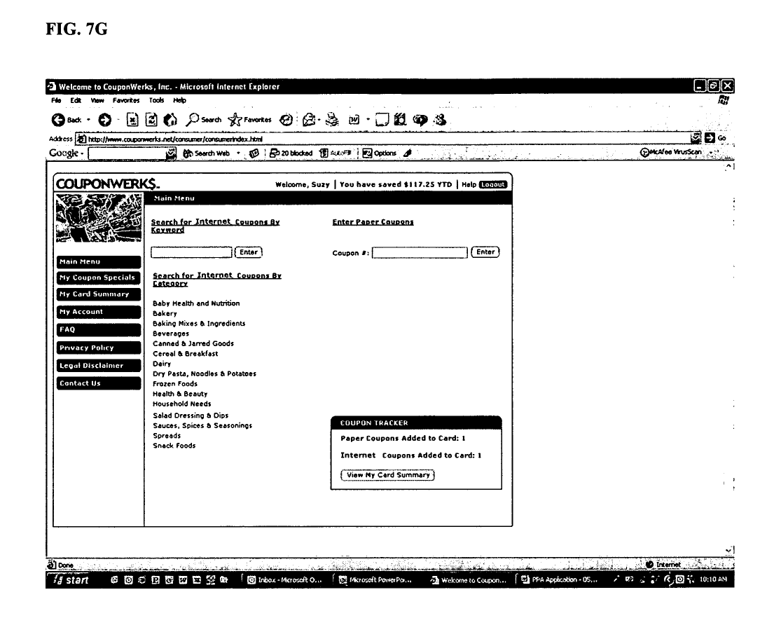

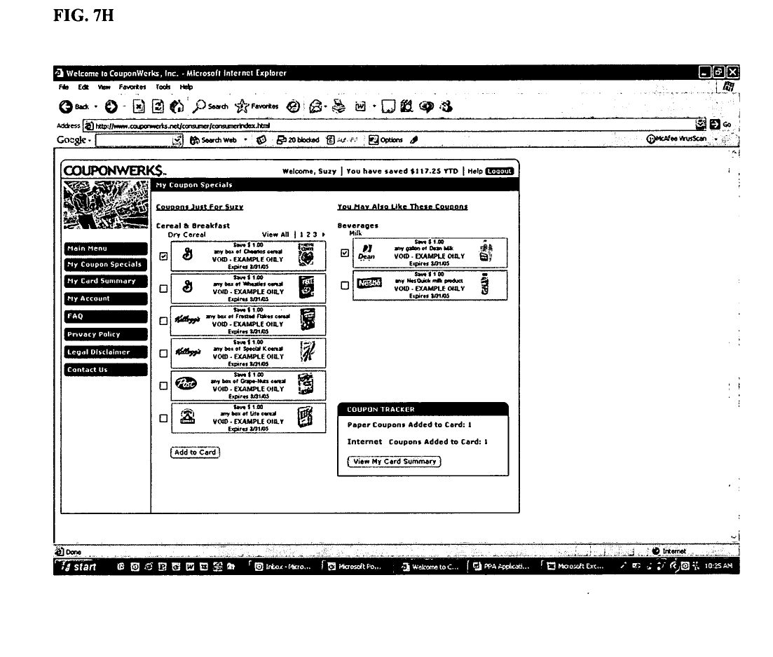

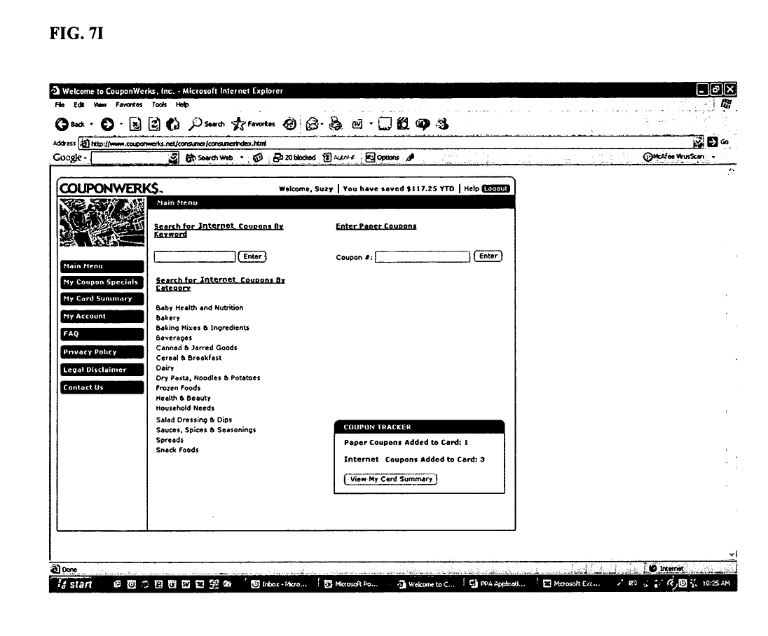

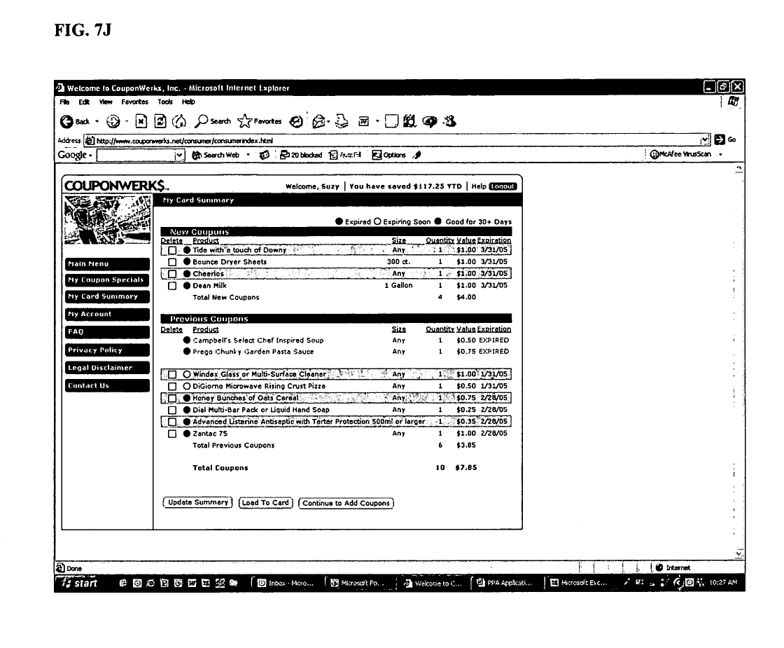

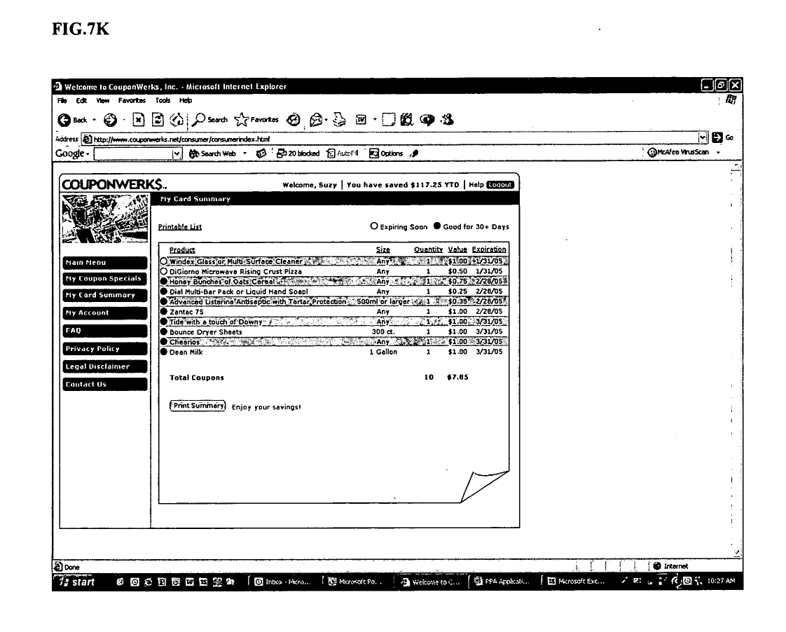

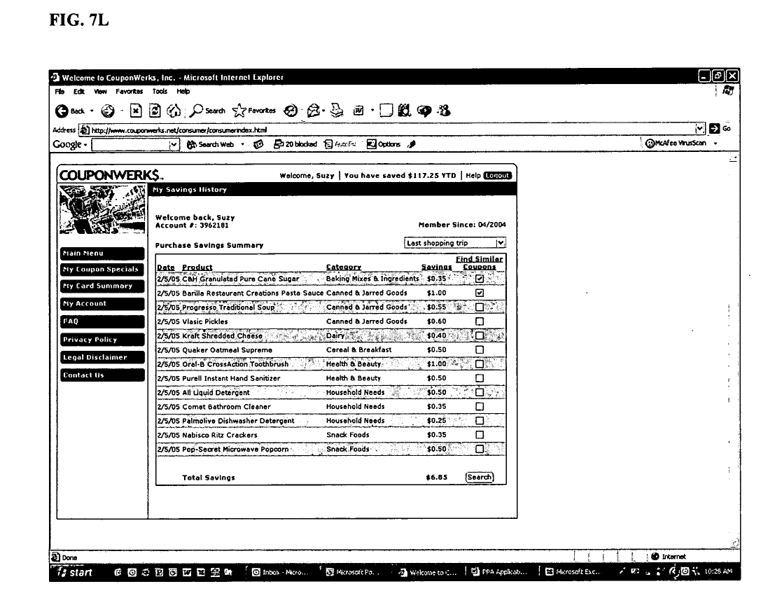

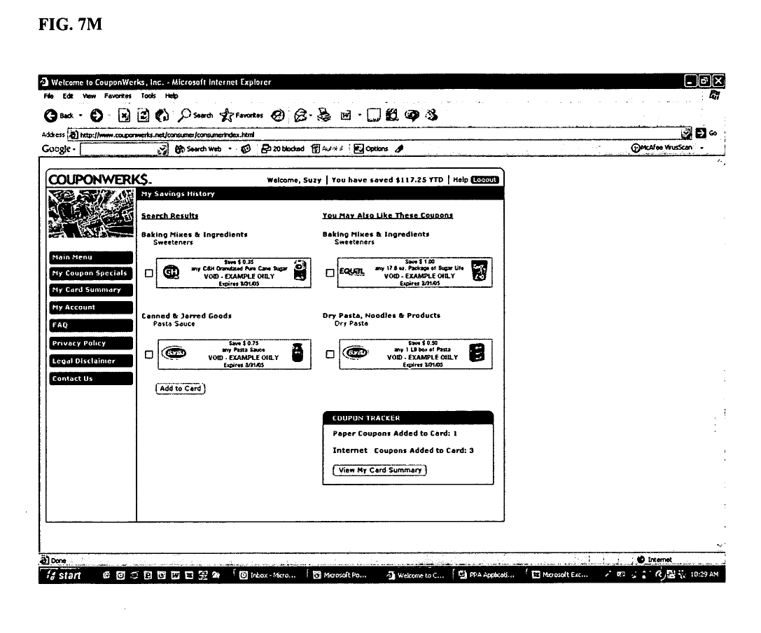

The process of a consumer entering a coupon and associating that coupon with the account will now be described in greater detail with the aid of FIGS. 7A-7M. After successfully authenticating with the system to access the consumer's account, the consumer arrives at the “Main Menu” as shown in FIG. 7A. The preferred methods to add coupons include, but are not limited to, entering the code from a paper coupon, performing a keyword search for Internet coupons posted on the website and searching by product category for Internet coupons posted on the website.

In order to associate a paper coupon with their account, a consumer must first provide the coupon information to the system. As shown in FIG. 7B, this can be done by entering a coupon identification code that identifies the coupon into the interface. A coupon identification code can be the numeric barcode data of a coupon. It should be understood that the coupon identification code also can be a batch code that correlates to multiple coupons. In this way, the consumer needs only enter a single batch code rather than multiple numeric barcodes to associate an assortment of coupons.

Once a coupon identification code is entered, the system software and hardware verifies that the coupon code is valid before associating the coupon to the consumer's account. A coupon can be validated by comparing the entered coupon identification code with a set of previously known valid codes in a stored database. Coupon codes entered in conformance with industry guidelines and recognized NSC's, MIN's, Family Codes, Value Codes, Check Digits, EAN-128 Extended Codes and GTIN (Global Trade Item Number) Codes can be compared with a database of valid codes. It will be obvious to one of skill in the art that this system is not limited to codes under the current industry guidelines and can be easily accommodated for other coupon code standards.

Once a coupon has been validated by the system, the system will display a verification screen to the consumer such as that shown in FIG. 7C. In this verification process, the system displays the offer corresponding to the code entered so that the consumer can confirm that the intended coupon was properly entered. If the coupon recognized by the system is correct, the consumer can add it to their account. If the coupon recognized by the system is incorrect, the consumer can go back to the paper coupon entry field and try again.

Upon confirmation, the coupon information is stored in the consumer's account for later use. As shown in FIG. 7D, the system may display to the consumer tracking information about the added coupons. The coupon tracker indicates to the user how many paper and Internet coupons have been added to their account during the current login session. In this example, the coupon tracker indicates one (1) paper coupon has been added, which occurred in FIG. 7C.

Coupons may also be associated to the consumer account in a number of different ways. FIG. 7E illustrates how a consumer adds a coupon to their account by searching by product category for Internet coupons posted on the website. In this example, the consumer selects the “Household Needs” category. Upon selecting the “Household Needs” category a drop-down list of sub-categories appears. In this example, the consumer selects the “Fabric Softener” category. The system then displays the Internet coupons available for the “Fabric Softener” category as shown in FIG. 7F. In this example, the consumer checks the box for the first coupon displayed in the category and adds it to their account. After confirmation, the coupon tracker indicates that one (1) Internet coupon has been added as shown in FIG. 7G.

FIG. 7H illustrates the “My Coupon Specials” page where relevant coupons based on the consumer's personal preferences or buying habits are displayed. Other coupons may also appear on the “My Coupon Specials” page from product manufacturers and/or retailers if the consumer meets their defined criteria for other targeted offers. Coupon offers for complimentary products that are related or typically purchased simultaneously with the targeted products may also be offered. In this example, coupons in the left-hand column feature dry cereal products. If the consumer is interested in dry cereal, they may also be interested in a complimentary product like milk. As such, the coupons in the right-hand column feature milk. In this example, the consumer checks the box for the first cereal product in the left-hand column and the first milk product in the right-hand column to be added to their account. Addition of coupons to the consumer's account results in updating the coupon tracker, as shown in FIG. 71. In this example, the coupon tracker indicates a total of one (1) paper coupon and three (3) Internet coupons have been added during this login session.

FIG. 7J illustrates the “My Card Summary” page. This page lists all the Previous Coupons remaining in the account after the user's last shopping trip, plus the New Coupons added during the current login session. A red, yellow, green color scheme indicates the expiration status of the coupons. The color green indicates a coupon will not expire for 30 days or more. The yellow color indicates a coupon is expiring soon. The red color scheme indicates a coupon has expired and is no longer available for use. If a coupon has expired, it will only appear on the “My Card Summary” page one time to notify the user that it is no longer available for use. If like Internet coupons are available for the coupons indicated to be expired, the expired coupons will contain a hyperlink the consumer can click which will redirect the current web page to another web page listing the like Internet coupons currently available for use. If valid coupons appear on the summary that are no longer of interest, the consumer may delete them from their account. In this example, the consumer keeps all of the coupons listed and confirms them for future use.

FIG. 7K illustrates the summary in printable format. The consumer can print the list to reference their coupon offers available at the next shopping trip.

FIG. 7L illustrates the “My Savings History” page. By default, it will display the coupons used at the consumer's last shopping trip, their respective values and the total amount saved. Other periods can be selected to view more detailed savings history. If the consumer would like to search for similar coupons to ones previously used, they can check the box corresponding to a particular coupon for which they would like to find similar coupons and search. In this example, the user checks the box for the first two coupons, C&H Granulated Pure Cane Sugar and Barilla Restaurant Creation Pasta Sauce, and searches for similar coupons.

FIG. 7M illustrates the search results from FIG. 7K. The results yield the same coupon for C&H Granulated Pure Cane Sugar and a similar coupon for Barilla Pasta Sauce in the left-hand column. Additionally, the right-hand column contains suggestions for one similar and one complimentary product. Instead of C&H Granulated Pure Cane Sugar, Equal Sugar Lite is suggested. To compliment Barilla Pasta Sauce, Barilla Pasta is suggested.

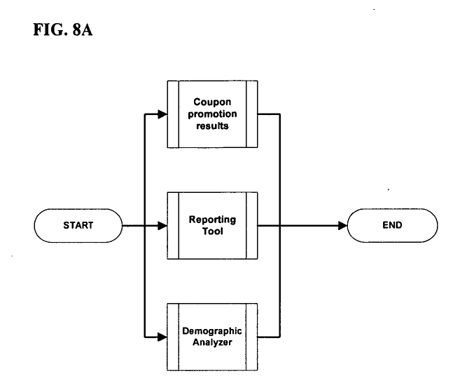

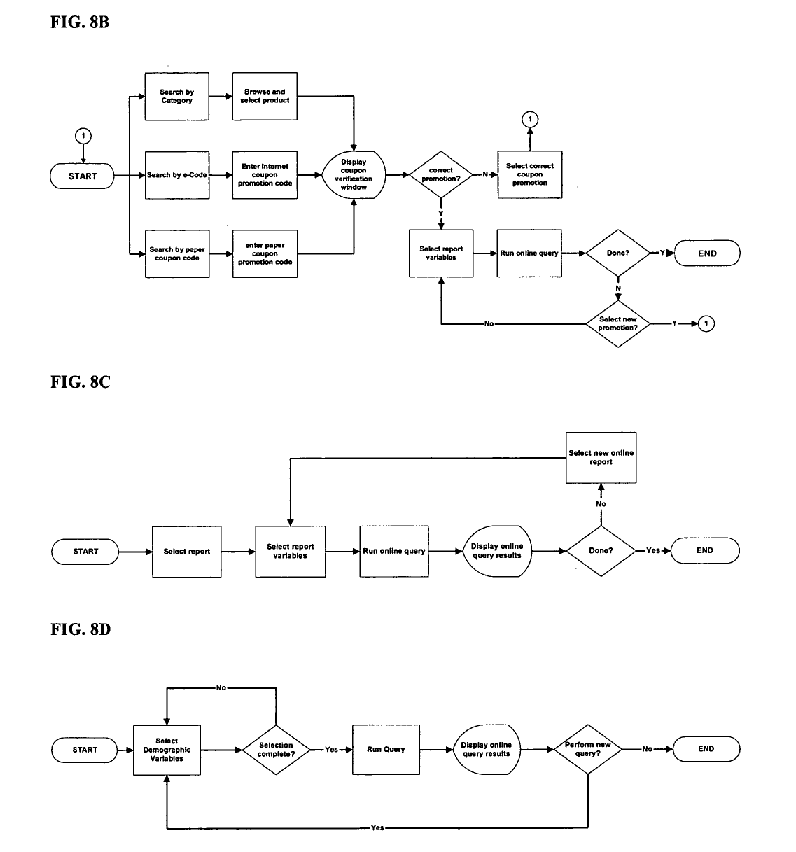

FIG. 8A illustrates the manufacturer web application process flow. Upon successful login to the manufacturer web application, the user is brought to a main menu. The preferred features include, but are not limited to, Coupon Promotion Results, existing and/or user defined reports from the Reporting Tool and the Demographic Analyzer.

The top branch of the manufacturer web application process flow illustrated in FIG. 8A represents how the user views Coupon Promotion Results. Since the web applications for the consumer, manufacturer and retailer access a common data warehouse, coupon use and transaction data can be accessed and analyzed in real-time. The preferred methods to search for Coupon Promotion Results are illustrated in FIG. 8B in greater detail.

FIG. 8B illustrates the Coupon Promotion Results search process flow of the manufacturer web application. The preferred methods to search for coupon promotion results include, but are not limited to, searching by category, searching by e-code and searching by paper coupon code.

Upon searching by product category, the system displays a list of product categories from which the user can choose, each of which contains more specific sub-categories. For example, if the user selects the “Frozen Foods” category, a drop-down list of product sub-categories appears. When the user selects a sub-category, let's say “Pizza”, a second drop-down list appears displaying all of the coupons corresponding to the “Pizza” sub-category. The user then selects one of the coupon promotions listed. A coupon promotion verification will be displayed to confirm the promotion selected is correct. If the promotion is correct, the user can select the report variables and query the data on that promotion. If the promotion is incorrect, the user can try again. The user has the ability, but is not limited to, printing the report results, exporting report results to Excel, clearing the results, querying data for a different time period, querying data with different sort variables or returning to the “Main Menu”.

Upon searching by e-code, an Internet coupon promotion verification will be displayed to confirm the promotion selected is correct. If the promotion is correct, the user can select the report variables and query the data on that promotion. If the promotion is incorrect, the user can try again. The user has the ability, but is not limited to, printing the report results, exporting report results to Excel, clearing the results, querying data for a different time period, querying data with different sort variables or returning to the “Main Menu”.

Upon searching by paper coupon code, a paper coupon promotion verification will be displayed to confirm the promotion selected is correct. If the promotion is correct, the user can select the report variables and query the data on that promotion. If the promotion is incorrect, the user can try again. The user has the ability, but is not limited to, printing the report results, exporting report results to Excel, clearing the results, querying data for a different time period, querying data with different sort variables or returning to the “Main Menu”.

The middle branch of the manufacturer web application process flow illustrated in FIG. 8A represents how the user accesses the Reporting Tool. The preferred method to run existing and/or user defined reports from the system is illustrated in FIG. 8C in greater detail.

FIG. 8C illustrates the Reporting Tool search process flow of the manufacturer web application. A list of existing and/or user defined reports are displayed. The user can select the desired report and select the report variables. Once the variables are selected, the user runs the online query to return the report results. Once the report is displayed, the user has the ability, but is not limited to, printing the report results, exporting report results to Excel, clearing the results, querying data for a different time period or returning to the list of existing and/or user defined reports on the “Main Menu”.

The bottom branch of the manufacturer web application process flow illustrated in FIG. 8A represents how the user accesses the Demographic Analyzer. The preferred methods to search the member database are illustrated in FIG. 8D in greater detail.

FIG. 8D illustrates the Demographic Analyzer search process flow of the manufacturer web application. Based on the demographic variables the user selects, the Demographic Analyzer queries the system to display the number of the present inventions members that correspond to the search. The preferred variables include, but are not limited to, age, gender, ethnic group, marital status, children in household, education level, income level and geographic location.

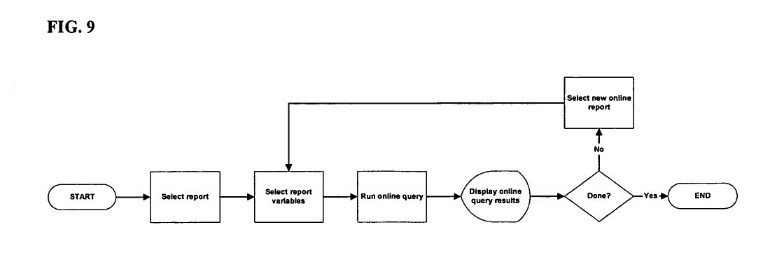

FIG. 9 illustrates the retailer web application process flow. Upon successful login to the retailer web application, the user is brought to a main menu. From the “Main Menu”, the user can select the desired report and select the report variables. Once the variables are selected, the user runs the online query to return the report results. Once the report is displayed, the user has the ability, but is not limited to, printing the report results, exporting report results to Excel, clearing the results, querying data for a different time period or returning to the list of existing and/or user defined reports on the “Main Menu”.

While the various descriptions of the present invention are described above, it should be understood that various features can be used singly or in combination thereof. Therefore, this invention is not to be limited to the specific preferred embodiments depicted herein. Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly set forth in the appended claims.

What is claimed is:

1. A computer system for facilitating the use of coupons for electronic presentment and processing comprising:
a transceiver adapted to receive coupon information from a communication network;
a storage device for storing coupon information received from the transceiver, a database containing a set of known coupon information values, and a plurality of customer accounts;
a comparator adapted to retrieve the coupon information from the storage device and to validate the coupon information by comparing the coupon information with the database of known coupon information values; and
a linker adapted to associate the coupon information with the customer account upon successful validation of the coupon information and to store the coupon information in the customer account.

2. The computer system of claim 1 wherein the communication network is the Internet.

3. The computer system of claim 1 wherein the coupon information is a coupon identification code.

4. The computer system of claim 3 wherein the coupon identification code conforms with industry guidelines or recognized NSC's, MIN's, Family Codes, Value Codes, Check Digits, EAN-128 Extended Codes and GTIN (Global Trade Item Number) Codes.

5. The computer system of claim 4 wherein the comparator validates the coupon information by comparing at least one of NSC's, MIN's, Family Codes, Value Codes, Check Digits, EAN-128 Extended Codes or GTIN Codes against a list of NSC's, MIN's, Family Codes, Value Codes, Check Digits, EAN-128 Extended Codes or GTIN Codes in the stored database.

6. A method for facilitating the use of coupons for electronic presentment and processing comprising:
maintaining a customer account;
receiving coupon information from a customer over a communication network;
verifying the coupon information to determine if the coupon is valid;
associating the coupon information with the customer account.

7. The method of claim 6 wherein the receiving information about a coupon from a customer over a communication network comprises receiving information over the Internet via a web-based interface.

8. The method of claim 6 wherein the coupon information comprises a coupon identification code.

9. The method of claim 6 further comprising the step of linking the customer account with a unique customer identifier.

10. The method of claim 8 wherein validating the coupon identification code comprises comparing at least one part of the coupon identification code with a database of known codes.

11. The method of claim 10 wherein at least one part of the coupon identification code is a NSC, MIN, Universal Family Code, Super Summary Family Code, Summary Family Code, 992 Bypass Family Code, Value Code, Check Digit, EAN-128 Extended Code or GTIN Code.

12. The method of claim 11 further comprising the step of removing the coupon associated in a customer account from the customer account when the unique customer identifier is used at a retail point of sale.

13. The method of claim 12 wherein the unique customer identifier is a card.

14. The method of claim 12 wherein the unique customer identifier is a personal identification number.

15. A method for a customer to register coupons for electronic presentment and processing comprising:
providing an authorization code to a computer system;
accessing a customer account on the computer system;
transmitting coupon information to the computer system over a communication network;
causing the computer system to validate the coupon and to associate the coupon with the customer account.

16. The method of claim 16 wherein the coupon information comprises a coupon identification code.
